(19) United States
(12) Patent Application Publication
(10) Pub. No.: US 2006/0154149 A1
(43) Pub. Date: Jul. 13, 2006

(54) Lithium secondary battery

(76) Inventors: Juichi Arai, Shirosato (JP); Mituru Kobayasi, Hitachiota (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/296,277

(22) Filed: Dec. 8, 2005

(30) Foreign Application Priority Data
Dec. 10, 2004 (JP) 2004-357502

(51) Int. Cl. H01M 10/40; H01M 4/50; H01M 4/52

(52) U.S. Cl. 429/332; 429/331; 429/231.1; 429/224; 429/231.3; 429/223; 429/231.6; 429/221

(57) ABSTRACT

This invention provides a lithium secondary battery comprising a container that contains a positive electrode capable of intercalating and deintercalating lithium ions, a negative electrode capable of intercalating and deintercalating lithium ions, a separator disposed between the positive electrode and the negative electrode, and an organic electrolyte. Such electrolyte comprises the cyclic carbonate solvent represented by formula 1, the chain carbonate solvent represented by formula 2, and the chain ester solvent represented by formula 3.

### TECHNICAL FIELD

The present invention relates to a novel lithium secondary battery that has a high charge/discharge capacity and that can be suitably used for hybrid-electric vehicles and the like.

### BACKGROUND ART

From the viewpoint of environmental protection and energy conservation, hybrid-electric vehicles powered by conventional engines with electric motors have been developed and manufactured. Also, the development of fuel-cell hybrid vehicles, which will be powered by fuel cells instead of engines in the future, is being actively attempted. A secondary battery capable of repetitive electric charge/discharge is indispensable as the energy source for such hybrid-electric vehicles.

Particularly, a lithium secondary battery is useful due to its high operating voltage and high discharge capacity. Thus, the significance thereof as a future power source for hybrid vehicles has increased. An electrolyte for a lithium secondary battery is required to have high voltage resistance, and an organic electrolyte comprising an organic solvent is used to fulfill such requirement. However, an organic solvent has poor lithium salt solubility, and electrical conductivity is strongly temperature dependent. When the lithium secondary battery is operated at room temperature, accordingly, the operating properties thereof are significantly deteriorated under low temperature conditions.

At present, a carbonate compound is predominantly used as an electrolyte solvent for a lithium secondary battery because of its high voltage resistance. A cyclic carbonate solvent has high lithium salt solubility, although viscosity thereof is high. In contrast, a chain carbonate solvent has low viscosity and poor lithium salt solubility. Accordingly, cyclic carbonate is mixed with chain carbonate, and the resulting mixture is generally used as an electrolyte. JP Patent Publication (Unexamined) No. 2-148665 (1990) proposes a method of improving low temperature performance wherein asymmetric ethyl methyl carbonate is used as chain carbonate; however, improvement in properties was limited in respect of lithium salt solubility.

As a measure for overcoming such drawbacks, the use of an acetate solvent that has a smaller molecular weight, lower viscosity, and a lower melting point than those of ethyl methyl carbonate is proposed (JP Patent Publication (Unexamined) No. 9-245838 (1998)).

### SUMMARY OF THE INVENTION

Compared with a carbonate solvent, an acetate solvent disadvantageously has poorer reduction resistance. When an acetate is used solely or when two or more acetates are used in combination, resistance disadvantageously becomes increased during the cycle. Coatings are provided on the electrodes in order to inhibit an increase in resistance during the cycle. With such technique, however, the original object to improve low temperature performance cannot be attained.

An object of the present invention is to provide a lithium secondary battery with improved low temperature performance without deterioration of the cycle properties of the lithium secondary battery.

In the present invention, electrical conductivity at ordinary to low temperature conditions is improved by adjusting an electrolyte solvent and an additive, an electrode-coating material is mixed in order to inhibit changes in resistance during the charge/discharge cycle, and a lithium salt consisting of an anion having a high molecular weight is mixed in order to reduce the resistance of the electrode-electrolyte interface under low temperature conditions. This is the most important feature of the present invention.

Specifically, the present invention provides a lithium secondary battery comprising a container that contains a positive electrode capable of intercalating and deintercalating lithium ions, a negative electrode capable of intercalating and deintercalating lithium ions, a separator disposed between the positive electrode and the negative electrode, and an organic electrolyte, wherein the organic electrolyte comprises:

a cyclic carbonate solvent represented by formula 1: 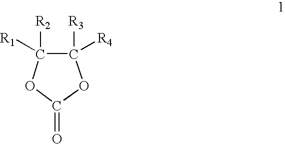
wherein R₁, R₂, R₃, and R4 each independently represent any of hydrogen, fluorine, chlorine, alkyl having 1 to 3 carbon atoms, and fluorinated alkyl, and they may be the same or different;

a chain carbonate solvent represented by formula 2: 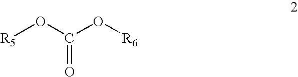
wherein R₅ and R₆ each independently represent any of hydrogen, fluorine, chlorine, alkyl having 1 to 3 carbon atoms, and fluorinated alkyl, and they may be the same or different; and

a chain ester solvent represented by formula 3: 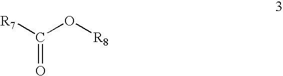
wherein R₇ and R₈ each independently represent any of hydrogen, fluorine, chlorine, alkyl having 1 to 3 carbon atoms, and fluorinated alkyl, and they may be the same or different.

Further, the organic electrolyte comprises at least one of:

a compound represented by formula 4: 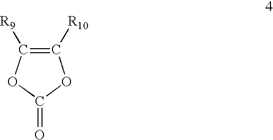
wherein R₉ and R₁₀ each independently represent any of hydrogen, fluorine, chlorine, alkyl having 1 to 3 carbon atoms, and fluorinated alkyl, and they may be the same or different; and

a compound represented by formula 5:

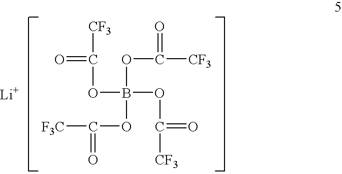

### BRIEF DESCRIPTION OF THE DRAWINGS

FIG. 1 shows a correlation between a lithium salt concentration and the electrical conductivity of the electrolyte according to the present invention.

FIG. 2 shows a correlation between temperature and the electrical conductivity of the electrolyte according to the present invention.

FIG. 3 is a half-sectional view showing the coin-type battery according to the present invention.

FIG. 4 shows a correlation between the direct-current (DC) resistance and the life of the coin-type battery according to the present invention.

FIG. 5 is a half-sectional view showing the spiral-wound battery according to the present invention.

### DESCRIPTION OF REFERENCE NUMERALS

1: aluminum foil of positive electrode current collector
2: positive electrode layer
3: copper foil of negative electrode
4: negative electrode layer
5: negative electrode case (cover)
6: positive electrode case
7: separator
8: gasket
9: negative electrode lead wire
10: positive electrode lead wire
11: positive electrode insulator
12: negative electrode insulator
13: negative electrode battery can
14: gasket
15: positive electrode battery cover

### DETAILED DESCRIPTION OF THE INVENTION

An electrolyte used for implementing the present invention can comprise, as a solvent represented by formula 1, ethylene carbonate (EC), propylene carbonate (PC), butylene carbonate (BC), trifluoropropylene carbonate (TFPC), chloroethylene carbonate (ClEC), trifluoroethylene carbonate (TFEC), difluoroethylene carbonate (DFEC), vinyl ethylene carbonate (VEC), or the like. Use of EC is particularly preferable in terms of negative electrode coating. Also, addition of a small amount of ClEC, FEC, or VEC can produce satisfactory cycle properties, concerning electrode coating. Further, use of a small amount of TFPC or DFEC is preferable since such substances are capable of coating the positive electrode. 0

Further, an electrolyte can comprise, as a solvent represented by formula 2, dimethyl carbonate (DMC), ethyl methyl carbonate (EMC), diethyl carbonate (DEC), methyl propyl carbonate (MPC), ethyl propyl carbonate (EPC), trifluoromethyl ethyl carbonate (TFMEC), 1,1,1-trifluoroethyl methyl carbonate (TFEMC), or the like.

A DMC solvent is highly compatible and it is suitably mixed with EC or another substance. The melting point of a DEC solvent is lower than that of a DMC solvent, and the DEC solvent can exhibit satisfactory low temperature performance. EMC has an asymmetric molecular structure and a low melting point, and thus is preferable from the perspective of exhibiting satisfactory low temperature performance. EPC and TFMEC each independently have a propylene side chain and an asymmetry molecular structure. Thus, they are suitably used as solvents for adjusting low temperature performance. TFEMC has a stronger dipole moment via partial fluorination of its molecules. Thus, TFEMC is suitably used for maintaining the dissociative property of a lithium salt at low temperatures, and it is effective for exhibiting good low temperature performance.

An electrolyte can comprise, as a solvent represented by formula 3, methyl formate (FA), ethyl formate (FE), methyl acetate (MA), ethyl acetate (EA), methyl propionate (PM), ethyl propionate (PE), trifluoromethyl acetate (TFMA), trifluoroethyl acetate (TFEA), or the like. Since FA and FE each independently have low molecular weight and low viscosity, they are suitably used for improving low temperature performance. MA and EA each independently have molecules with strong dipole moments, they are effective for maintaining the dissociative property at low temperatures, and thus are suitable for improving low temperature performance. TFMA and TFEA have adequate molecular weights, they effectively adjust the formulation of the solution at low temperatures, and they are suitably used as auxiliary mixed solvents for improving the low temperature performance.

An electrolyte can further comprise, as a compound represented by formula 4, vinylene carbonate (VC), methyl vinylene carbonate (MVC), dimethyl vinylene carbonate (DMVC), ethyl vinylene carbonate (EVC), diethyl vinylene carbonate (DEVC), or the like. Since VC has a low molecular weight, it can provide a dense coating on the electrode. MVC, DMVC, EVC, DEVC, and the like in which alkyl groups have been substituted by VC can provide electrode coatings with low density in accordance with the size of the alkyl chain and effectively improve low temperature performance.

Use of a compound represented by formula 5 in combination with one of the compounds represented by formula 4 or a plurality thereof results in adjustment of the composition or density of the electrode coating, and thus, such compound is effective for improving low temperature performance. Such compound is accumulated on the surface of the negative electrode carbonaceous material at the time of initial charging. Thus, this compound is considered to form a preferable route of lithium ion migration.

Lithium salts that are used for an electrolyte are not particularly limited. For example, inorganic lithium salts, such as LiPF₆, LiBF₄, LiClO₄, LiI, LiCl, and LiBr, and organic lithium salts, such as LiB[OCOCF₃]₄, LiB[OCOCF₂CF₃]₄, LiPF₄(CF₃)₂, LiN(SO₂CF₃)₂, and LiN(SO₂CF₂CF₃)₂, can be used. LiPF₆, which is extensively used for household batteries, is particularly preferable from the viewpoint of stable quality. Also, LiB[OCOCF₃]₄ is effective in terms of satisfactory dissociative property, solubility, and electrical conductivity at a low concentration.

As positive electrode materials, LiMn4Ni₃Co₂O₂, LiMn_{1/3}Ni_{1/3}Co_{1/3}O₂, LiMn₃Ni₄Co₃O₂, LiMn_{3.5}Ni₃Co₃Al_{0.5}O₂, LiMn_{3.5}Ni₃Co₃B_{0.5}O₂, LiMn_{3.5}Ni₃Co₃Fe_{0.5}O₂, LiMn_{3.5}Ni₃Co₃Mg_{0.5}O₂, and the like represented by the formula LiMnₓM1_{y}M2_{z}O₂ (wherein M1 is either Co or Ni; and M2 is at least one member selected from among Co, Ni, Al, B, Fe, Mg, and Cr, provided that x+y+z=1, 0.2≦x≦0.6, 0.2≦y≦0.4, and 0.05≦z≦0.4) can be employed. An increased Ni content in the composition results in a higher electric capacity. An increased Co content results in an improved discharge capacity under low temperature conditions. An increased Mn content results in reduced material costs. Additive elements have the effects of stabilizing the cycle properties, and a high Ni content can result in improved safety. LiMn_{1/3}Ni_{1/3}Co_{1/3}O₂ is particularly preferable as a lithium battery material for HEV in terms of satisfactory low temperature performance and cycle stability. Further, electrically conductive carbonaceous materials, such as graphite, amorphous, or active carbon materials, are preferably mixed in order to construct the electrode.

Examples of negative electrode materials that can be used include: natural graphite; synthetic graphite produced by burning starting materials such as composite carbonaceous materials prepared by coating natural graphite via dry chemical vapor deposition (CVD) or wet spraying, resin materials such as epoxy or phenol resins, or pitch materials obtained from petroleum or coal; carbonaceous materials such as amorphous carbon materials; lithium metal capable of intercalating and deintercalating lithium via formation of a compound with lithium; and oxides or nitrides of the group IV elements, such as silicon, germanium, and tin capable of intercalating and deintercalating lithium via formation of a compound with lithium or insertion of lithium into crystal pores. Among these materials, carbonaceous materials are particularly satisfactory in terms of electrical conductivity, low temperature performance, and cycle stability. In the present invention, carbonaceous materials with large interplanar spacings (d₀₀₂) are preferable in terms of quick charge/discharge and low temperature properties. The materials with large interplanar spacings (d₀₀₂), however, often have lowered electric capacity at the initial charging stage or low charge/discharge efficiency. Accordingly, d₀₀₂ is preferably not more than 0.39 nm. Further, highly conductive carbonaceous materials, such as graphite, amorphous, or active carbon materials, are preferably mixed in order to construct the electrode.

The high-power lithium secondary battery according to the present invention has an improved DCR and charge/discharge capacity at low temperatures compared with conventional lithium secondary batteries. Thus, the lithium secondary battery of the present invention can be extensively utilized as the power supply for a hybrid vehicle, or the power supply or back-up power supply for the electric control system of a vehicle. The battery of the present invention is also preferable for use as the power supply for electric power tools or industrial instruments such as forklifts.

The discharge capacity of the lithium secondary battery of the present invention at low temperatures is particularly improved, and thus, it is effective to apply the battery of the present invention to vehicles that are often used in cold climates. When batteries are assembled and used in the form of a module comprising a few hundred-volt batteries, the number of batteries to be assembled can be reduced due to satisfactory low temperature performance. This results in a reduction in the size and weight of the resulting module.

The present invention can provide a lithium secondary battery with improved low temperature performance without deterioration of the cycle properties of the lithium secondary battery.

This description includes part or all of the contents as disclosed in the description of Japanese Patent Application No. 2004-357502, which is a priority document of the present application.

### Preferred Embodiments of the Invention

Hereafter, preferred embodiments of the present invention are described in detail with reference to the following examples.

### EXAMPLE 1

A 1M lithium salt (LiPF₆) was dissolved in EC:DMC:EMC:MA (3:3:3:1) to prepare an electrolyte.

### COMPARATIVE EXAMPLE 1

A 1M lithium salt (LiPF₆) was dissolved in EC:DMC:DEC (1:1:1) to prepare a control electrolyte.

(Comparison of Electrical Conductivity)

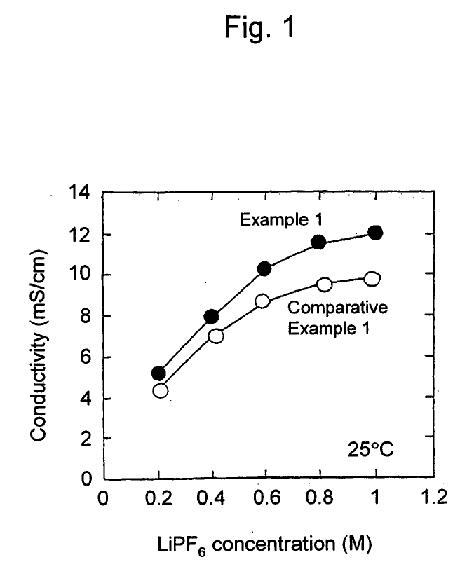

FIG. 1 is a diagram showing the results of a comparison of electrical conductivity in relation to the lithium salt concentration between Example 1 and Comparative Example 1 based on an alternating current impedance of 3 kHz. As shown in FIG. 1, electrical conductivity can be improved at each lithium salt concentration and the maximal electrical conductivity can be increased by changing the composition of the solvent that constitutes the electrolyte from DEC to a mixture of EMC and MA.

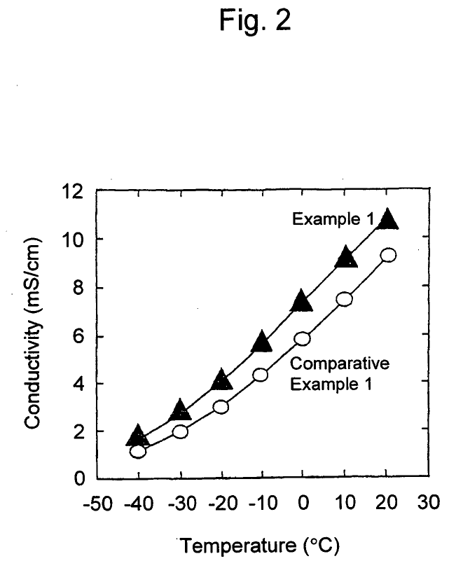

FIG. 2 is a diagram showing the results of comparison of temperature dependence of the electrolyte comprising 1M LiPF₆ dissolved therein of Example 1 and that of Comparative Example 1. The electrolyte of Example 1 maintained electrical conductivity higher than that of the electrolyte of Comparative Example 1 at temperatures as low as −40° C. Thus, use of EMC in combination with MA is effective for improving electrical conductivity of the electrolyte.

Subsequently, a positive electrode paste was prepared using LiMn_{1/3}Ni_{1/3}Co_{1/3}O₂ as a positive electrode material, carbon black (CB1) and black graphite (GF1) as electrically conductive agents, and polyvinylidene fluoride (PVDF) as a binder. N-methylpyrrolidone (NMP) was used as a solvent to bring the ratio of the solid contents to the following level on a dry basis: LiMn_{1/3}Ni_{1/3}Co_{1/3}O₂:CB1:GF1:PVDF=86:9:2:3. The positive electrode paste was applied to aluminum foil as a positive electrode collector 1, dried at 80° C., pressed with a pressure roller, and then dried at 120° C. to form a positive electrode layer 2 on the positive electrode collector 1.

A negative electrode paste was prepared using Carbotron P (Kureha Chemical Industry Co., Ltd.) as a negative electrode material, carbon black (CB2) as an electrically conductive agent, and PVDF as a binder. NMP was used as a solvent to bring the ratio of the solid contents to the following level on a dry basis: Carbotron P:CB2:PVDF=88:5:7. The negative electrode paste was applied to copper foil as a negative electrode collector 3, dried at 80° C., pressed with a pressure roller, and then dried at 120° C. to form a negative electrode layer 4 on the negative electrode collector 3.

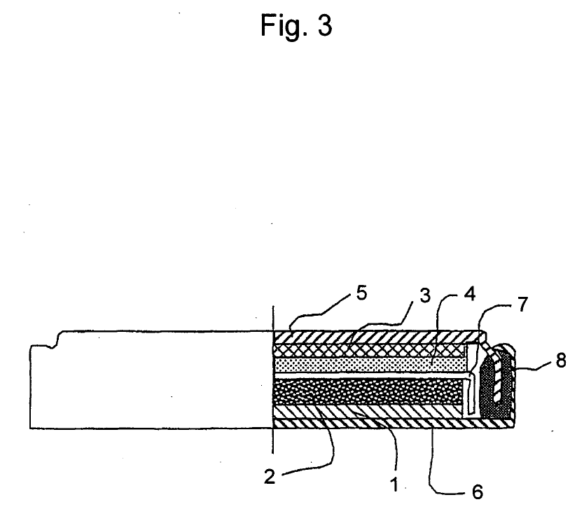

FIG. 3 is a half-sectional view showing the coin-type battery prepared in the example. The positive and the negative electrodes thus prepared were cut into circular shapes of 15 mm in diameter, the positive electrode was placed in the case 6, the 25-μm-thick polyethylene separator 7 was provided on the positive electrode, the electrolyte 1 of Example 1 was injected into the battery, the negative electrode was placed on the separator 7, and the case 5 was caulked via a gasket 8 to form the coin-type battery having the structure shown in FIG. 3 (Example 1).

### EXAMPLE 2

A 1M lithium salt (LiPF₆) was dissolved in EC:DMC:EMC:MA (3:3:3:1), and VC was added thereto to 0.8% by weight to prepare an electrolyte.

### EXAMPLE 3

A 1M lithium salt (LiPF₆) was dissolved in EC:DMC:EMC:MA (3:3:3:1), and VC to 0.8% by weight and 0.01M compound represented by formula 5 (i.e., tetrakis[trifluoroacetoxy]borate-lithium (TTFBL)) were added thereto to prepare an electrolyte.

Coin-type batteries into which the electrolytes had been injected were prepared in the same manner as in Example 1 using the electrolytes prepared in Comparative Example 1, Example 2, and Example 3.

(Evaluation of Cell Resistance)

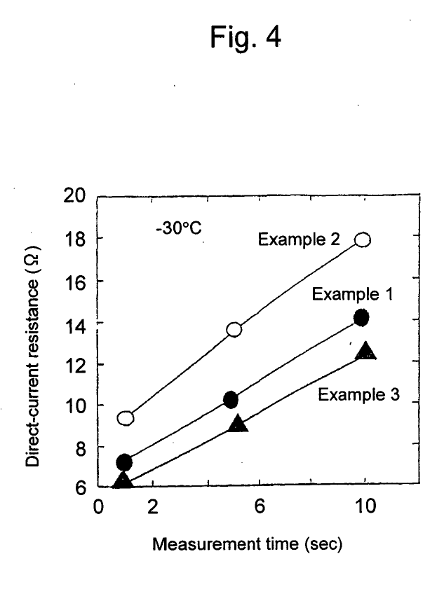

FIG. 4 is a diagram showing the results of evaluating and comparing the direct current resistance (DCR) of the batteries prepared above at −30° C. The prepared batteries were charged at a constant current of 2 mA and further charged at a constant voltage of 4.1 V until the charging current declined to less than 20 μA. Thereafter, charging was halted for 30 minutes, and the batteries were discharged at a constant current of 2 mA to 2.7 volts. This procedure was repeated 3 times, and the batteries were further charged at a constant current of 2 mA to 3.8 volts. In this state, the batteries were discharged at 20 mA, 40 mA, and 60 mA to the final voltage of 2.5 V, current-voltage (I-V) characteristics were measured, and the battery resistance at the time of discharge was evaluated based on the I-V curve. VC was mixed in Example 2, which resulted in increased resistance on the electrode surface. With the addition of TTFBL, increased resistance at low temperatures caused by the addition of VC could be inhibited in the case of the battery prepared in Example 3. This can result from a decreased density of the electrode coating caused by bulky TTFBL anions, which can facilitate the migration of lithium ions under low temperature conditions and lower the battery resistance.

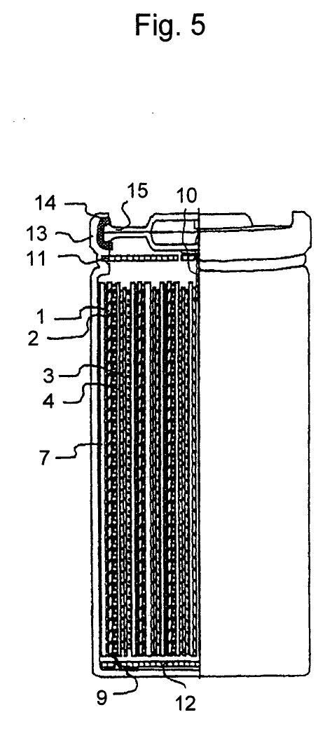

FIG. 5 is a half-sectional view showing the spiral-wound battery according to the example. The spiral-wound battery shown in FIG. 5 was prepared, and the battery resistance at −30° C. and the pulse cycle properties were evaluated and compared. The battery was charged at a constant current of 0.7 A to 4.1 volts and further charged at a constant voltage of 4.1 V until the charging current declined to 20 mA. Thereafter, charging was halted for 30 minutes, and the batteries were discharged at 0.7 A to 2.7 volts. This procedure was repeated 3 times. Subsequently, the batteries were further charged at a constant current of 0.7 A to 3.8 volts, discharged at 10 A for 10 seconds, charged at a constant current to 3.8 volts, discharged at 20 A for 10 seconds, charged to 3.8 volts, and then discharged at 30 A for 10 seconds. Based on the I-V characteristics at this state, the DCR of the battery was evaluated. A pulse cycle testing was carried out in an incubator at 50° C. via repetition of the charge/discharge cycle at 20 A for 2 seconds. The electric capacity at 25° C. and DCR at 25° C. and at −30° C. 1,000 hours later were evaluated.

Table 1 shows the initial properties and the properties after the pulse cycle of the spiral-wound batteries shown in FIG. 5 that were prepared in Examples 1 to 3 and Comparative Example 1. The battery prepared in Example 1 comprising MA in its electrolyte exhibited a 10% to 15% reduction in the initial DCR compared with the battery prepared in Comparative Example 1 consisting of carbonate. Specifically, a 10%-15% improvement in the charge/discharge capacity can be expected. Also, an increase in DCR after the pulse cycle was inhibited by 10% to 15% compared with the battery prepared in Comparative Example 1.

Further, a battery prepared by adding VC to the battery of Example 1 exhibited slightly increased initial DCR compared with the battery of Example 1, although increase in DCR after the pulse cycle was remarkably inhibited. This is considered to result from a phenomenon, whereby the side reaction of the electrolyte during the pulse cycle is inhibited by the electrode coating provided by VC.

The battery of Example 3 that was prepared by adding TTFBL to the battery of Example 2 exhibited a remarkably improved initial DCR at 25° C. and at −30° C. Further, the increase in the DCR after the pulse cycle was smaller than that of Example 2, although the DCR was satisfactorily low in terms of the absolute value. This indicates that the battery of Example 3 had satisfactory cycle properties. It was accordingly confirmed that MA was effective for improving low temperature performance, VC was effective for improving the cycle properties, and TTFBL could remarkably improve the low temperature properties.

TABLE 1

| | Initial properties | | | Properties after 1000-hour pulse cycle | | |
|---|---|---|---|---|---|---|
| | Electric | DCR/mΩ | DCR/mΩ | Electric | DCR/mΩ | DCR/mΩ |
| Battery | capacity/mAh | (25° C.) | (−30° C.) | capacity/mAh | (25° C.) | (−30° C.) |
| Ex. 1 | 570 | 63 | 620 | 465 | 93 | 930 |
| Ex. 2 | 560 | 68 | 675 | 485 | 82 | 820 |
| Ex. 3 | 580 | 58 | 595 | 490 | 73 | 740 |
| Comp. Ex. 1 | 560 | 70 | 720 | 485 | 120 | 1250 |

### EXAMPLE 4

A 1M lithium salt (LiPF₆) was dissolved in EC:DMC:EMC:EA (3:3:3:1), and VC was added thereto to 0.8% by weight to prepare an electrolyte. The resulting electrolyte was injected into a battery having the same specifications as the battery of Example 1 to prepare the battery of Example 4.

### EXAMPLE 5

A 1M lithium salt (LiPF₆) was dissolved in EC:DMC:EMC:EA (3:3:3:1), and VC to 0.8% by weight and O.OIM TTFBL were added thereto to prepare an electrolyte. The resulting electrolyte was injected into a battery having the same specifications as the battery of Example 1 to prepare the battery of Example 5.

### EXAMPLE 6

A 1M lithium salt (LiPF₆) was dissolved in EC:DMC:EMC:PM (3:3:3:1), and VC was added thereto to 0.8% by weight to prepare an electrolyte. The resulting electrolyte was injected into a battery having the same specifications as the battery of Example 1 to prepare the battery of Example 6.

### EXAMPLE 7

A 1M lithium salt (LiPF₆) was dissolved in EC:DMC:EMC:MA (3:3:3:1), and VC to 0.8% by weight and 0.01M TTFBL were added thereto to prepare an electrolyte. The resulting electrolyte was injected into a battery having the same specifications as the battery of Example 1 to prepare the battery of Example 7.

### EXAMPLE 8

A 1M lithium salt (LiPF₆) was dissolved in EC:DMC:EMC:PE (3:3:3:1), and VC was added thereto to 0.8% by weight to prepare an electrolyte. The resulting electrolyte was injected into a battery having the same specifications as the battery of Example 1 to prepare the battery of Example 8.

### EXAMPLE 9

A 1M lithium salt (LiPF₆) was dissolved in EC:DMC:EMC:PE (3:3:3:1), and VC to 0.8% by weight and 0.01M TTFBL were added thereto to prepare an electrolyte. The resulting electrolyte was injected into a battery having the same specifications as the battery of Example 1 to prepare the battery of Example 9.

### EXAMPLE 10

A 1M lithium salt (LiPF₆) was dissolved in EC:DMC:EMC:TFMA (3:3:3:1), and VC was added thereto to 0.8% by weight to prepare an electrolyte. The resulting electrolyte was injected into a battery having the same specifications as the battery of Example 1 to prepare the battery of Example 10.

### EXAMPLE 11

A 1M lithium salt (LiPF₆) was dissolved in EC:DMC:EMC:TFMA (3:3:3:1), and VC to 0.8% by weight and 0.01M TTFBL were added thereto to prepare an electrolyte. The resulting electrolyte was injected into a battery having the same specifications as the battery of Example 1 to prepare the battery of Example 11.

(Evaluation of Properties of Batteries of Examples 4 to 11)

Table 2 shows the results of the test and the evaluation of the batteries of Examples 4 to 11 carried out in the same manner as that used for the batteries of Examples 1 to 3. The battery of Example 4 comprising EA instead of MA exhibited a DCR lowered by 3 ml at 25° C. and by 20 mΩ at −30° C. compared with the battery of Example 2. Further, the battery of Example 5 comprising the electrolyte of Example 4 that additionally comprises TTFBL exhibited a DCR lowered by 3 mΩ at 25° C. and by 30 mΩ at −30° C. compared with the battery of Example 4.

The DCR of the battery of Example 6 comprising PM instead of MA was 2 mΩ lower at 25° C. and 45 mΩ lower at −30° C. compared with the battery of Comparative Example 1. Further, the battery of Example 7 comprising the electrolyte of Example 6 that additionally comprises TTFBL exhibited a DCR lowered by 7 mΩ at 25° C. and by 55 mΩ at −30° C. compared with the battery of Comparative Example 1.

The DCR of the battery of Example 8 comprising PE instead of MA was 3 mΩ lower at 25° C. and 40 mΩ lower at −30° C. compared with the battery of Comparative Example 1. Further, the battery of Example 9 comprising the electrolyte of Example 8 that additionally comprises TTFBL exhibited a DCR lowered by 7 mΩ at 25° C. and by 95 mΩ at −30° C. compared with the battery of Comparative Example 1.

The DCR of the battery of Example 10 comprising TFMA instead of MA was 2 mΩ lower at 25° C. and 30 mΩ lower at −30° C. compared with the battery of Comparative Example 1. Further, the battery of Example 11 comprising the electrolyte of Example 10 that additionally comprises TTFBL exhibited a DCR lowered by 8 mΩ at 25° C. and by 95 mΩ at −30° C. compared with the battery of Comparative Example 1. After the pulse cycle testing, the batteries of these examples maintained DCRs lower than that of the battery of Comparative Example 1 both at 25° C. and at −30° C.

TABLE 2

| | Initial properties | | | Properties after 1000-hour pulse cycle | | |
|---|---|---|---|---|---|---|
| | Electric | DCR/mΩ | DCR/mΩ | Electric | DCR/mΩ | DCR/mΩ |
| Battery | capacity/mAh | (25° C.) | (−30° C.) | capacity/mAh | (25° C.) | (−30° C.) |
| Ex. 4 | 580 | 65 | 655 | 470 | 85 | 840 |
| Ex. 5 | 585 | 62 | 625 | 460 | 82 | 810 |
| Ex. 6 | 575 | 68 | 675 | 480 | 87 | 820 |
| Ex. 7 | 570 | 64 | 635 | 465 | 81 | 795 |
| Ex. 8 | 585 | 67 | 680 | 485 | 88 | 780 |
| Ex. 9 | 580 | 63 | 625 | 475 | 83 | 745 |
| Ex. 10 | 585 | 68 | 690 | 475 | 84 | 770 |
| Ex. 11 | 580 | 62 | 625 | 465 | 81 | 745 |

### EXAMPLE 12

A 1M lithium salt (LiPF₆) was dissolved in EC:DMC:EMC:MA (3:3:3:1), and MVC was added thereto to 0.8% by weight to prepare an electrolyte. The resulting electrolyte was injected into a battery having the same specifications as the battery of Example 1 to prepare the battery of Example 12.

### EXAMPLE 13

A 1M lithium salt (LiPF₆) was dissolved in EC:DMC:EMC:MA (3:3:3:1), and MVC to 0.8% by weight and 0.01M TTFBL were added thereto to prepare an electrolyte. The resulting electrolyte was injected into a battery having the same specifications as the battery of Example 1 to prepare the battery of Example 13.

### EXAMPLE 14

A 1M lithium salt (LiPF₆) was dissolved in EC:DMC:EMC:MA:TFPC (3:2:3:1:1), and VC was added thereto to 0.8% by weight to prepare an electrolyte. The resulting electrolyte was injected into a battery having the same specifications as the battery of Example 1 to prepare the battery of Example 14.

### EXAMPLE 15

A 1M lithium salt (LiPF₆) was dissolved in EC:DMC:EMC:MA:TFPC (3:2:3:1:1), and VC to 0.8% by weight and 0.01M TTFBL were added thereto to prepare an electrolyte. The resulting electrolyte was injected into a battery having the same specifications as the battery of Example 1 to prepare the battery of Example 15.

### EXAMPLE 16

A 1M lithium salt (LiPF₆) was dissolved in EC:DMC:EMC:MA:VEC (3:2.5:3:1:0.5), and VC was added thereto to 0.8% by weight to prepare an electrolyte. The resulting electrolyte was injected into a battery having the same specifications as the battery of Example 1 to prepare the battery of Example 16.

### EXAMPLE 17

A 1M lithium salt (LiPF₆) was dissolved in EC:DMC:EMC:MA:VEC (3:2.5:3:1:0.5), and VC to 0.8% by weight and 0.O1M TTFBL were added thereto to prepare an electrolyte. The resulting electrolyte was injected into a battery having the same specifications as the battery of Example 1 to prepare the battery of Example 17.

### EXAMPLE 18

A 1M lithium salt (LiPF₆) was dissolved in EC:DMC:EMC:MA:ClEC (3:2.5:3:1:0.5), and VC was added thereto to 0.8% by weight to prepare an electrolyte. The resulting electrolyte was injected into a battery having the same specifications as the battery of Example 1 to prepare the battery of Example 18.

### EXAMPLE 19

A 1M lithium salt (LiPF₆) was dissolved in EC:DMC:EMC:MA:ClEC (3:2.5:3:1:0.5), and VC to 0.8% by weight and 0.01M TTFBL were added thereto to prepare an electrolyte. The resulting electrolyte was injected into a battery having the same specifications as the battery of Example 1 to prepare the battery of Example 19.

(Evaluation of Properties of Batteries of Examples 12 to 19)

Table 3 shows the results of the test and the evaluation of the batteries of Examples 12 to 19 carried out in the same manner as that used for the batteries of Examples 1 to 3. The battery of Example 12 comprising the electrolyte of Example 2 with MVC being substituted with VC exhibited a DCR lowered by 3 mΩ at 25° C. and by 0 mΩ at −30° C. compared with the battery of Comparative Example 1. Further, the battery of Example 13 comprising the electrolyte of Example 12 that additionally comprises TTFBL exhibited a DCR lowered by 6 mΩ at 25° C. and by 105 mΩ at −30° C. compared with the battery of Comparative Example 1.

The DCR of the battery of Example 14 comprising the electrolyte of Example 2 that additionally comprises TFPC was 1 mΩ lower at 25° C. and 70 mΩ lower at −30° C. compared with the battery of Comparative Example 1. Further, the battery of Example 15 comprising the electrolyte of Example 14 that additionally comprises TTFBL exhibited a DCR lowered by 3 mΩ at 25° C. and by 95 mΩ at −30° C. compared with the battery of Comparative Example 1.

The DCR of the battery of Example 16 comprising the electrolyte of Example 2 that additionally comprises VEC was 3 mΩ lower at 25° C. and 50 mΩ lower at −30° C. compared with the battery of Comparative Example 1. Further, the battery of Example 17 comprising the electrolyte of Example 16 that additionally comprises TTFBL exhibited a DCR lowered by 8 mΩ at 25° C. and by 75 mΩ at −30° C. compared with the battery of Comparative Example 1.

The DCR of the battery of Example 18 comprising the electrolyte of Example 2 that additionally comprises ClEC was 2 mΩ lower at 25° C. and 45 mΩ lower at −30° C. compared with the battery of Comparative Example 1. Further, the battery of Example 19 comprising the electrolyte of Example 18 that additionally comprises TTFBL exhibited a DCR lowered by 7 mΩ at 25° C. and by 45 mΩ at −30° C. compared with the battery of Comparative Example 1. After the pulse cycle testing, the batteries of these examples maintained DCRs lower than that of the battery of Comparative Example 1 both at 25° C. and at −30° C.

TABLE 3

| | Initial properties | | | Properties after 1000-hour pulse cycle | | |
|---|---|---|---|---|---|---|
| | Electric | DCR/mΩ | DCR/mΩ | Electric | DCR/mΩ | DCR/mΩ |
| Battery | capacity/mAh | (25° C.) | (−30° C.) | capacity/mAh | (25° C.) | (−30° C.) |
| Ex. 12 | 565 | 67 | 660 | 480 | 84 | 855 |
| Ex. 13 | 550 | 64 | 615 | 475 | 83 | 835 |
| Ex. 14 | 560 | 69 | 650 | 475 | 85 | 885 |
| Ex. 15 | 555 | 67 | 625 | 470 | 84 | 850 |
| Ex. 16 | 580 | 67 | 670 | 465 | 87 | 875 |
| Ex. 17 | 575 | 62 | 645 | 460 | 86 | 835 |
| Ex. 18 | 585 | 68 | 675 | 475 | 89 | 895 |
| Ex. 19 | 570 | 63 | 655 | 465 | 88 | 880 |

The batteries prepared in Examples 1 to 19 can exhibit improved low temperature performance without deterioration of the cycle properties of the lithium secondary batteries.

The high-power lithium secondary batteries prepared in the examples of the present invention have improved DCRs under low temperature conditions and the improved charge/discharge capacities under low temperature conditions compared with conventional lithium secondary batteries. Thus, such batteries can be extensively utilized as the power supply for a hybrid vehicle, or the power supply or back-up power supply for the electric control system of a vehicle. The battery of the present invention is also preferable for use as the power supply for electric power tools or industrial instruments such as forklifts.

The discharge capacity of the lithium secondary battery of the present invention at low temperatures is particularly improved, and thus, it is effective to apply the battery of the present invention to vehicles that are often used in cold climates. When batteries are assembled and used in the form of a module comprising a few hundred-volt batteries, the number of batteries to be assembled can be reduced due to satisfactory low temperature performance. This results in a reduction in the size and weight of the resulting module.

All publications, patents, and patent applications cited herein are incorporated herein by reference in their entirety.

What is claimed is:

1. A lithium secondary battery comprising a container that contains a positive electrode capable of intercalating and deintercalating lithium ions, a negative electrode capable of intercalating and deintercalating lithium ions, a separator disposed between the positive electrode and the negative electrode, and an organic electrolyte, wherein the organic electrolyte comprises:
a cyclic carbonate solvent represented by formula 1: 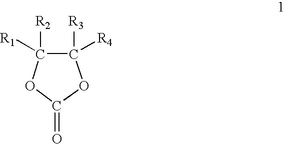
wherein R₁, R₂, R₃, and R₄ each independently represent any of hydrogen, fluorine, chlorine, alkyl having 1 to 3 carbon atoms, and fluorinated alkyl, and they may be the same or different;
a chain carbonate solvent represented by formula 2: 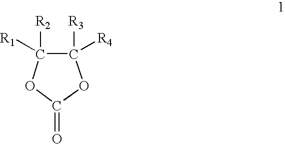
wherein R₅ and R₆ each independently represent any of hydrogen, fluorine, chlorine, alkyl having 1 to 3 carbon atoms, and fluorinated alkyl, and they may be the same or different; and
a chain ester solvent represented by formula 3: 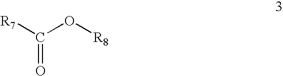
wherein R₇, R₈ each independently represent any of hydrogen, fluorine, chlorine, alkyl having 1 to 3 carbon atoms, and fluorinated alkyl, and they may be the same or different.

2. The lithium secondary battery according to claim 1, wherein the organic electrolyte comprises at least one of:
a compound represented by formula 4: 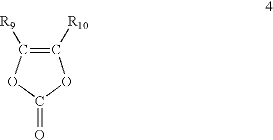
wherein R₉, R₁₀ each independently represent any of hydrogen, fluorine, chlorine, alkyl having 1 to 3 carbon atoms, and fluorinated alkyl, and they may be the same or different; and
a compound represented by formula 5:

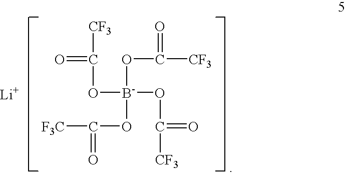

3. The lithium secondary battery according to claim 1, wherein the positive electrode comprises a lithium oxide composite represented by the formula LiMnₓM1_{y}M2_{z}O₂ (wherein M1 is either Co or Ni; and M2 is at least one member selected from among Co, Ni, Al, B, Fe, Mg, and Cr, provided that x+y+z=1, 0.2≦x≦0.6, 0.2≦y≦0.4, and 0.05≦z≦0.4).

4. The lithium secondary battery according to claim 1, wherein the negative electrode comprises at least one member selected from the group consisting of a carbonaceous material, an oxide comprising a group IV element, and a nitride comprising a group IV element.

5. The lithium secondary battery according to claim 4, wherein the positive electrode comprises a compound represented by the formula LiMn_{1/3}Ni_{1/3}Co_{1/3}O₂, and the negative electrode comprises the carbonaceous material having d₀₀₂ of 0.39 nm or lower.

6. The lithium secondary battery according to any one of claim 1 to claim 5, wherein the cyclic carbonate solvent represented by formula 1 is ethylene carbonate, the chain carbonate solvent represented by formula 2 is dimethyl carbonate or ethyl methyl carbonate, the chain ester solvent represented by formula 3 is methyl acetate, and the compound represented by formula 4 is vinylene carbonate.
